(19) United States
(12) Patent Application Publication
(10) Pub. No.: US 2024/0300461 A1
(43) Pub. Date: Sep. 12, 2024

(54) VEHICLE BRAKE ARRANGEMENT

(71) Applicant: HONDA MOTOR CO., LTD., Tokyo (JP)

(72) Inventors: Ryo UEKI, Tokyo (JP); Akihisa HIRATA, Tokyo (JP); Motomasa SUZUKI, Tokyo (JP)

(21) Appl. No.: 18/425,442

(22) Filed: Jan. 29, 2024

(30) Foreign Application Priority Data
Mar. 7, 2023 (JP) 2023-034226

(51) Int. Cl. B60T 11/22

(52) U.S. Cl. CPC B60T 11/22

(57) ABSTRACT

A vehicle brake arrangement includes: a reservoir tank mounted on an upper side of a master cylinder; and a guide member provided on a front end surface of the master cylinder, wherein the reservoir tank has an overextending portion extending forward beyond the master cylinder, and the guide member includes a fixed portion fixed to the master cylinder, and an extending portion extending forward from the fixed portion and overlapping in a vehicle up-down direction with the overextending portion.

### CROSS-REFERENCE TO RELATED APPLICATION

This application claims the benefit of priority under 35 U.S.C. §119 to Japanese Patent Application No. 2023-034226 filed on Mar. 7, 2023, the entire contents of which are incorporated herein by reference.

### TECHNICAL FIELD

The present invention relates to a vehicle brake arrangement including a master cylinder and a reservoir tank mounted on an upper side of the master cylinder.

### BACKGROUND OF THE INVENTION

Japanese Patent No. 3386765, for example, discloses a technique of making a master cylinder tilted clockwise in the event of a vehicle collision, by way of a front end region of the master cylinder and a guide member (mechanical forced guidance means) provided in an engine compartment.

### SUMMARY

### Problems to be Solved

On another note, a conventional master cylinder has been reduced in length in a vehicle front-rear direction, so that a reservoir tank mounted on the master cylinder may extend forward beyond a front end of the master cylinder.

Additionally, the reservoir tank has a jig set at a cap thereof for vacuuming, when air therein is evacuated, to have a downward load applied by the jig. However, in a case where the master cylinder is reduced in length in the vehicle front-rear direction to have the reservoir tank extending forward beyond the front end of the master cylinder, it is difficult to support the reservoir tank against the downward load.

The present invention has been devised in view of the above-identified problems and is intended to provide a vehicle brake arrangement to support a reservoir tank, even in a case where a master cylinder is reduced in length in a vehicle front-rear direction to have the reservoir tank extending forward beyond a front end of the master cylinder.

### Solution to Problems

A vehicle brake arrangement according to the present invention, to solve the above-identified problems, includes: a master cylinder attached to a dash panel of a vehicle; a reservoir tank mounted on an upper side of the master cylinder; and a guide member provided at a front end of the master cylinder, wherein the reservoir tank has an overextending portion extending forward beyond the master cylinder, and the guide member includes a fixed portion fixed to the master cylinder, and an extending portion extending forward from the fixed portion and overlapping in a vehicle up-down direction with the overextending portion.

### Advantageous Effects of the Invention

The present invention provides the vehicle brake arrangement to support the reservoir tank, even in a case where the master cylinder is reduced in length in the vehicle front-rear direction to have the reservoir tank extending forward beyond the front end of the master cylinder.

### BRIEF DESCRIPTION OF DRAWINGS

FIG. 1 is a perspective view of a vehicle brake arrangement according to an embodiment of the present invention;

FIG. 2 is a partially-enlarged perspective view of the vehicle brake arrangement in FIG. 1, as viewed from the front;

FIG. 3 is the vehicle brake arrangement in FIG. 2, as viewed from an arrowed direction A;

FIG. 4 is a perspective view of the vehicle brake arrangement in FIG. 1, as viewed obliquely from the front;

FIG. 5 is an enlarged perspective view of a fixed portion and an extending portion; and

FIG. 6 is an enlarged perspective view of a guide member.

### DETAILED DESCRIPTION

Hereinbelow, a description is given in detail of an embodiment of the present invention, with reference to the drawings as required. In the drawings, a “front-rear,” “right-left,” and “up-down” respectively indicate a vehicle front-rear direction, a vehicle width direction (right-left direction), and a vehicle up-down direction (vertical direction).

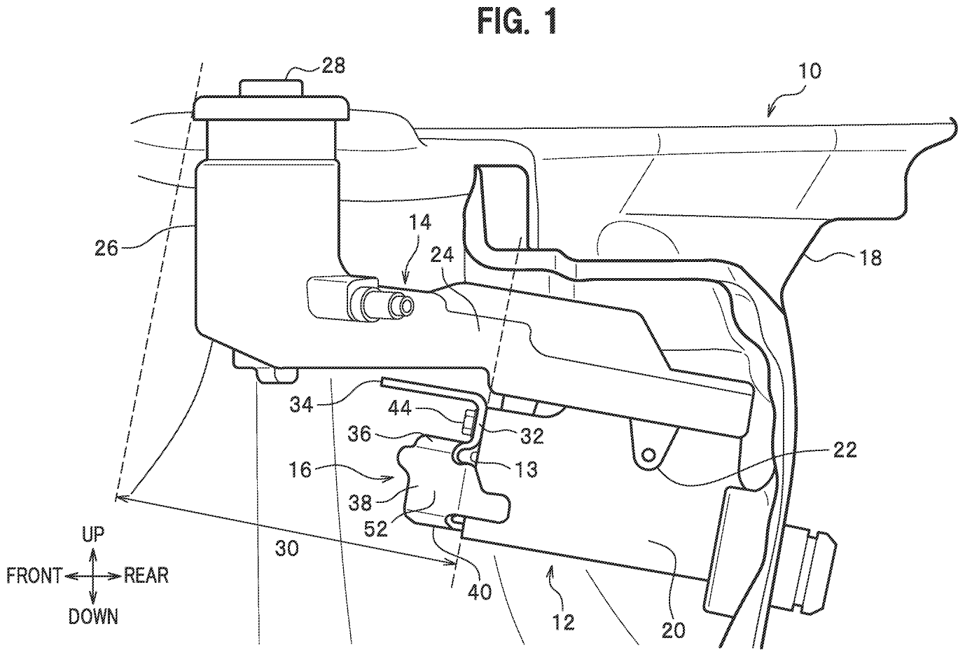

As shown in FIG. 1, a vehicle brake arrangement 10 according to the embodiment of the present invention includes a master cylinder 12, a reservoir tank 14, and a guide member 16.

The master cylinder 12 includes a cylinder 20, a piston (not shown), and a piston rod (not shown). The master cylinder 12 is attached at a rear end thereof to a lower dash panel 18. The cylinder 20 is in a tube shape having both ends in an axial direction thereof closed. The piston is housed in the cylinder 20 and reciprocated in an axial direction of the cylinder 20. The piston rod is linked to the piston and reciprocated integrally with the piston.

As shown in FIG. 1, the lower dash panel 18 is a boundary member between a power plant room, in which a power unit (not shown) such as an engine and/or a motor is/are arranged, and a vehicle compartment. The master cylinder 12 has a rear end thereof coupled with a brake pedal (not shown) via a pushrod (not shown).

The reservoir tank 14 is mounted on an upper side of the master cylinder 12 via a mounting strip 22. The reservoir 14 includes a tank body 24, tubular projection 26, and a cap 28. The tank body 24 is made of resin, for example, and stores inside brake fluid. The tubular projection 26 continues from a front end of the tank body 24 and projects upward. The cap 28 is provided to detachably open and close an opening (not shown) at an upper end of the tubular projection 26.

The reservoir tank 14 has an overextending portion 30 extending forward beyond a front end surface 13 of the master cylinder 12. The overextending portion 30 is composed of a portion of the tank body 24, extending forward beyond the front end surface 13 of the master cylinder 12, and the tubular projection 26 continuing from said portion of the tank body 24.

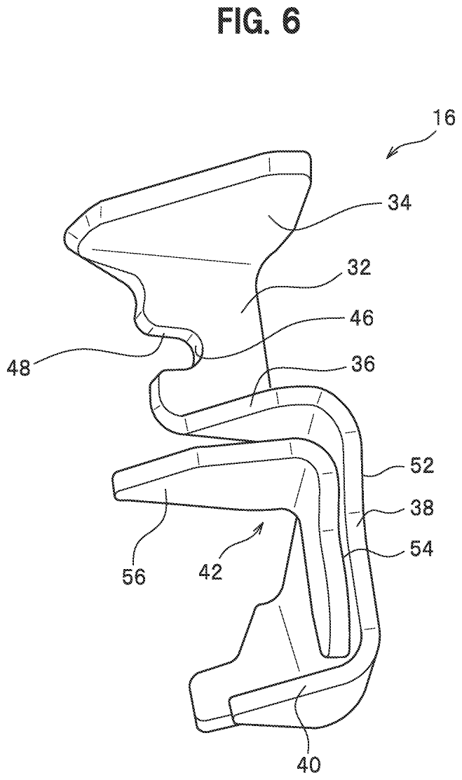

As shown in FIG. 1, the guide member 16 is on a lower side of the reservoir tank 14 and provided on the front end surface 13 of the master cylinder 12. As shown in FIG. 6, the guide member 16 includes a fixed portion 32, an extending portion 34, a first bent portion (bent portion) 36, an abutting portion 38, a second bent portion 40, and a reinforcing part 42. Note that the guide member 16 works to cause a power unit, such as an engine, to abut on the abutting portion 38 in the event of a frontal collision (including an offset collision) and guide the master cylinder 12 so as to be displaced outward in the vehicle width direction.

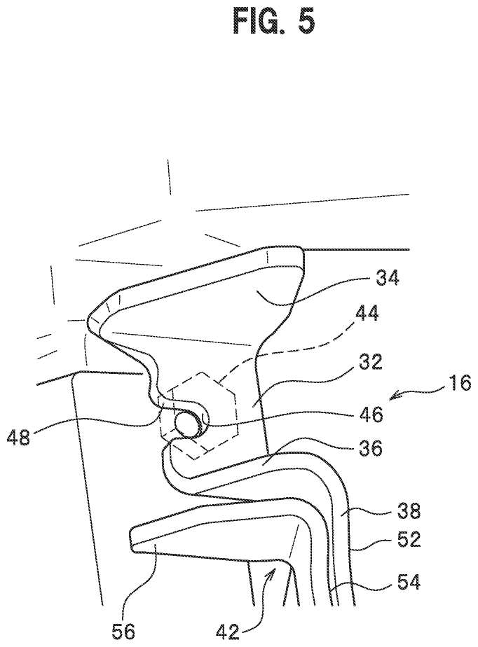

The fixed portion 32 comprises a flat plate portion having a flat surface, extending substantially parallel to the front end surface 13 of the master cylinder 12, and is fixed to the front end surface 13 of the master cylinder 12 via a screw (fixing member) 44 (see FIG. 1). As shown in FIG. 5, the fixed portion 32 has a fixing hole 46 through which the screw (fixing member) 44 is inserted, and a slit 48 continuing from the fixing hole 46 and opening outward in the vehicle width direction from the fixing hole 46.

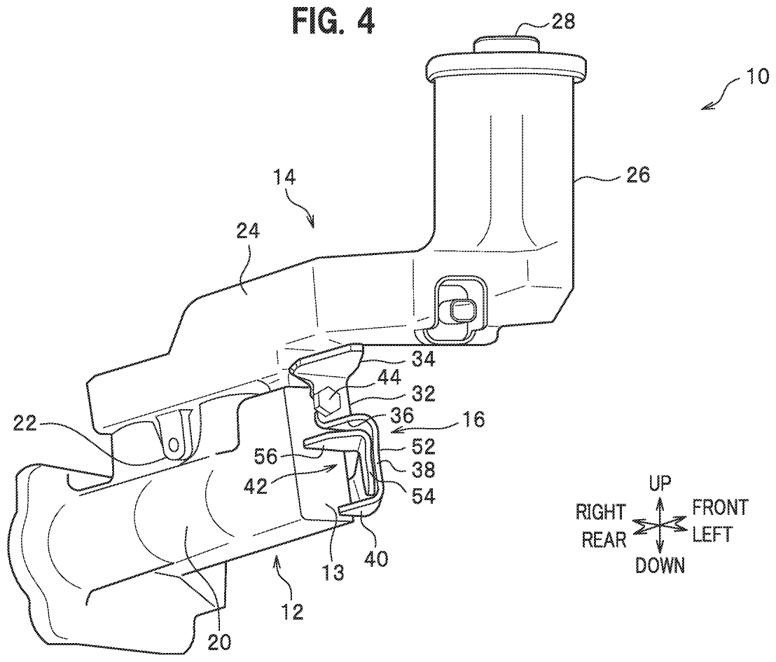

The extending portion 34 has a substantially triangle shape as viewed from bottom (see FIGS. 4 to 6), to extend forward from the fixed portion 32 and overlap in the vehicle up-down direction with the overextending portion 30 of the reservoir tank 14 (see FIG. 1). In other words, the extending portion 34 bends forward from an upper end of the fixed portion 32 and extends frontward by a predetermined length, along a lower end of the reservoir tank 14. Note that the extending portion 34 of the embodiment does not contact the lower end of the reservoir tank 14, but is not limited thereto and may contact said lower end.

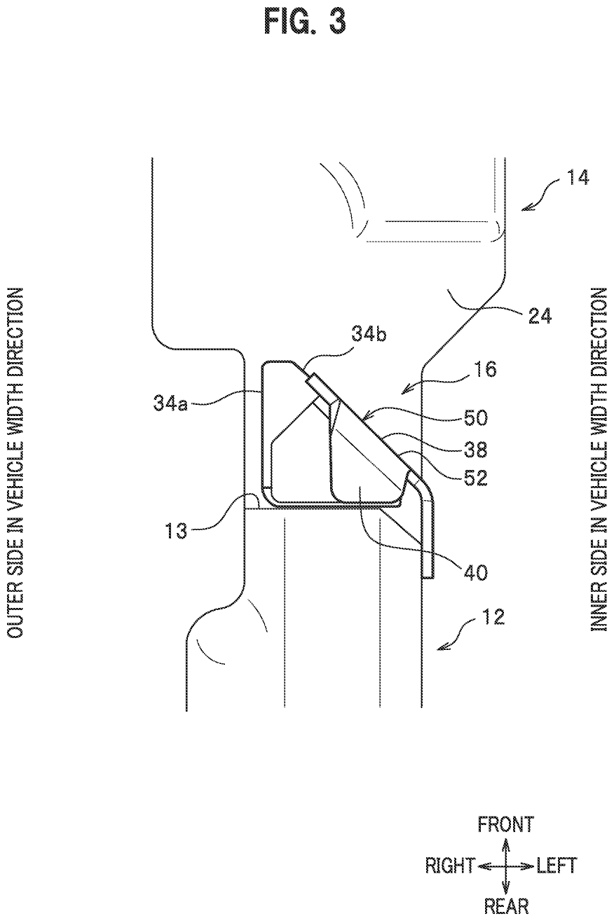

Additionally, the extending portion 34 has a tapered portion 50 having an inner region in the vehicle width direction thereof tapered as it extends frontward, as viewed from bottom. As shown in FIG. 3, the tapered portion 50 is composed of an outer extending portion 34a extending in the vehicle front-rear direction at an outer portion in the vehicle width direction thereof, and an inner extending portion 34b inclining inward in the vehicle width direction from said outer portion as it extends rearward. In other words, the extending portion 34 has an inner edge in the vehicle width direction thereof (tapered portion 50) inclining so as to be located outer in the vehicle width direction as it extends frontward.

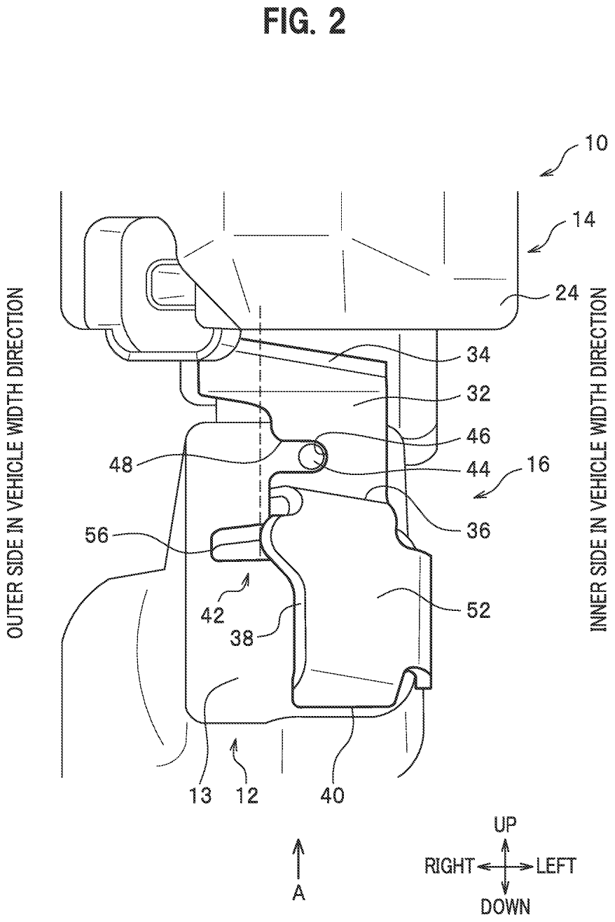

The fixed portion 32 continues, at a lower end thereof, to the first bent portion 36 bent forward (see FIGS. 4 and 6). The first bent portion 36 continues, at a front end thereof, to the abutting portion 38 (see FIGS. 2 and 4) which is inclined so as to come closer to the front end surface 13 of the master cylinder 12 as it extends inward in the vehicle width direction from an outer end thereof.

The abutting portion 38 has an abutting surface 52 continuing to the fixed portion 32 via the first bent portion 36 and inclined inward in the vehicle width direction (see FIG. 2). The extending portion 34 has at least a part thereof located outer in the vehicle width direction than the abutting surface 52 (see the dash line in FIG. 2). Additionally, the extending portion 34 has at least a part thereof located outer in the vehicle width direction than the fixed portion 32 (see

FIG. 2).

The abutting portion 38 continues, at a lower end thereof, to the second bent portion 40 bent rearward (toward the front end surface 13 of the master cylinder 12) (see FIG. 6).

The reinforcing part 42 is welded (such as by spot welding) and integrally joined to the abutting portion 38 (back surface thereof opposite to the abutting surface 52), on an outer side in the vehicle width direction of the abutting surface 52. The reinforcing part 42 includes a reinforcing surface 54 (see FIG. 6) overlapping in the vehicle width direction and vehicle front-rear direction with the abutting surface 52, and an extending-out portion 56 (see FIG. 2) bent from the reinforcing surface 54 and extending outward in the vehicle width direction along the front end surface 13 of the master cylinder 12. The reinforcing part 42 is separated from the fixed portion 32, extending portion 34, first bent portion 36, abutting portion 38, and second bent portion 40 of the guide member 16. The reinforcing part 42 is bent in a substantially L-shape, as viewed obliquely from the front (see FIG. 6).

The vehicle brake arrangement 10 of the embodiment is basically configured as described above, and advantageous effects thereof follow below.

The embodiment includes the guide member 16 provided on the front end surface 13 of the master cylinder 12. In the embodiment, the reservoir tank 14 has the overextending portion 30 extending forward beyond the master cylinder 12. The guide member 16 includes the fixed portion 32 fixed to the master cylinder 12, and the extending portion 34 extending forward from the fixed portion 32 and overlapping in the vehicle up-down direction with the overextending portion 30.

The embodiment allows for suitably supporting the overextending portion 30 from below by the extending portion 34 of the guide member 16, even in a case where the master cylinder 12 is reduced in length in the axial direction thereof to have the reservoir tank 14 extending forward beyond the master cylinder 12. As a result, the embodiment supports the overextending portion 30 by the extending portion 34 of the guide member 16, even in a case where the overextending portion 30 of the master cylinder 12 has a load inputted thereto so as to be displaced downward, for example, to prevent the reservoir tank 14 from being deformed to improve durability of the reservoir tank 14.

In addition, the fixed portion 32 of the embodiment is fixed to the front end surface 13 of the master cylinder 12. The guide member 16 has the abutting surface 52 continuing to the fixed portion 32 and inclined inward in the vehicle width direction. The extending portion 34 of the guide member 16 has at least a part thereof located outer in the vehicle width direction than the abutting surface 52.

With the extending portion 34 of the guide member 16 having at least a part thereof located outer in the vehicle width direction than the abutting surface 52 (see the dash line in FIG. 2), the embodiment suitably avoids the extending portion 34 intervening, in the event of a frontal collision load (including an offset load) having been inputted and a power unit such as an engine colliding with the abutting surface 52 of the guide member 16. As a result, the embodiment prevents the reservoir tank 14 from being deformed in the event of a frontal collision load having been inputted, to improve durability of the reservoir tank 14.

Further, the embodiment has at least a part of the extending portion 34 of the guide member 16 located outer in the vehicle width direction than the fixed portion 32.

With the embodiment formed to have at least a part of the extending portion 34 of the guide member 16 located outer in the vehicle width direction than the fixed portion 32, the embodiment suitably avoids the extending portion 34 intervening, in the event of a frontal collision load having been inputted and a power unit such as an engine colliding with the abutting surface 52 of the guide member 16. As a result, the embodiment prevents the reservoir tank 14 from being deformed in the event of a frontal collision load having been inputted, to improve durability of the reservoir tank 14.

Still further, the extending portion 34 of the embodiment has the tapered portion 50 having an inner region in the vehicle width direction thereof tapered as it extends frontward.

As a result, the embodiment allows for reliably securing an area of contact between the overextending portion 30 and the extending portion 34, to further improve durability for the reservoir tank 14 being deformed. Additionally, the embodiment suitably avoids the extending portion 34 intervening, in the event of a frontal collision load having been inputted and a power unit such as an engine colliding with the abutting surface 52 of the guide member 16.

Still further, the guide member 16 of the embodiment has the abutting surface 52 of the abutting portion 38 continuing from the fixed portion 32 via the first bent portion 36, and the reinforcing part 42 provided on an outer side in the vehicle width direction of the abutting surface 52. The reinforcing part 42 includes the reinforcing surface 54 overlapping, mainly in the vehicle width direction, with the abutting surface 52, and the extending-out portion 56 extending toward the front end surface 13 of the master cylinder 12 from the reinforcing surface 54.

With the reinforcing part 42 including the reinforcing surface 54 and the extending-out portion 56, the embodiment further improves durability for the reservoir tank 14 being deformed. Additionally, in the event of a frontal collision load having been inputted and a power unit such as an engine having abutted on the abutting surface 52 of the guide member 16, the embodiment transmits the load, inputted via the abutting surface 52, to the master cylinder 12 by the first bent portion 36 and the extending-out portion 56. Accordingly, the embodiment displaces (deforms) the master cylinder 12 outward in the vehicle width direction more reliably, in the event of a frontal collision load having been inputted.

Still further, the fixed portion 32 of the embodiment has the fixing hole 46 through which the screw (fixing member) 44 is inserted, and the slit 48 continuing from the fixing hole 46 and opening outward in the vehicle width direction from the fixing hole 46.

With the fixed portion 32 having the fixing hole 46 for the screw 44 and the slit 48, the embodiment allows the guide member 16 to be readily mounted later onto the screw 44, which has been fastened beforehand to the front end surface 13 of the master cylinder 12. As a result, the embodiment improves efficiency of the vehicle brake arrangement 10 being assembled.

### LIST OF REFERENCE SIGNS

10, vehicle brake arrangement; 12, master cylinder; 13, front end surface (of master cylinder); 14, reservoir tank; 16, guide member; 18, lower dash panel (dash panel); 30, overextending portion; 32, fixed portion; 34, extending portion; 36, first bent portion (bent portion); 42, reinforcing part; 44, screw (fixing member); 46, fixing hole; 48, slit; 50, tapered portion; 52, abutting surface; 54, reinforcing surface; 56, extending-out portion

What is claimed is:

1. A vehicle brake arrangement comprising:
a master cylinder attached to a dash panel of a vehicle;
a reservoir tank mounted on an upper side of the master cylinder; and
a guide member provided at a front end of the master cylinder, wherein
the reservoir tank has an overextending portion extending forward beyond the master cylinder, and
the guide member includes a fixed portion to be fixed to the master cylinder, and an extending portion extending forward from the fixed portion and overlapping in a vehicle up-down direction with the overextending portion.

2. The vehicle brake arrangement according to claim 1, wherein
the fixed portion is fixed to a front end surface of the master cylinder,
the guide member has an abutting surface continuing to the fixed portion and inclined inward in a vehicle width direction, and
the extending portion has at least a part thereof located outer in the vehicle width direction than the abutting surface.

3. The vehicle brake arrangement according to claim 2, wherein
at least a part of the extending portion is located outer in the vehicle width direction than the fixed portion.

4. The vehicle brake arrangement according to claim 2, wherein
the extending portion has a tapered portion having an inner region in the vehicle width direction thereof tapered as it extends frontward.

5. The vehicle brake arrangement according to claim 2, wherein
the guide member has the abutting surface continuing from the fixed portion via a bent portion, and a reinforcing part provided on an outer side in the vehicle width direction of the abutting surface, and
the reinforcing part includes a reinforcing surface overlapping in the vehicle width direction with the abutting surface, and an extending-out portion extending toward the front end surface of the master cylinder.

6. The vehicle brake arrangement according to claim 2, wherein
the fixed portion has a fixing hole through which a fixing member is inserted, and a slit continuing from the fixing hole and opening outward in the vehicle width direction from the fixing hole.
